(19) United States
(12) Patent Application Publication
(10) Pub. No.: US 2008/0193201 A1
(43) Pub. Date: Aug. 14, 2008

(54) Optical Assembly Structure Comprising a Connecting Body with Thermal Expansion Compensations Means

(75) Inventors: Yim-Bun Patrick Kwan, Aalen (DE); Stefan Xalter, Oberkochen (DE); Fraser Morrison, Edinburgh (GB); Maurice Wijckmans, ME Eindhoven (DE); David Kendall, Oberkochen (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: CARL ZEISS SMT AG, Oberkochen (DE)

(21) Appl. No.: 11/579,458

(22) PCT Filed: Aug. 22, 2004
(86) PCT No.: PCT/EP2004/009384

§ 371 Date: Mar. 31, 2008

(30) Foreign Application Priority Data
May 3, 2004 (EP) 04010446.5

(51) Int. Cl. F16L 13/00

(52) U.S. Cl. 403/30; 403/265

(57) ABSTRACT

An optical assembly comprises a connecting body (1) consisting of at least a first and a second part (3, 4), the body (1) being connected to an assembly means (2) of a ceramic material wherein the assembly means (2) consists of at least a first and a second part (17, 18) separated by a gap (19).

The invention is related to an assembly structure comprising a connecting body.

From U.S. Pat. No. 6,099,193 and DE 197 55 482 A1 a composite or connecting body is known which is assembled of at least two bodies. The first body is made of a first material and the second body is made of a second material. Each of the two bodies has at least one connecting surface and these connecting surfaces are mutually adjacent. The two connecting bodies are wrung upon each other on at least one connecting surface. The two connecting surfaces are connected to each other by wringing and on at least one of these two surfaces, one or more recesses are provided for an adhesive location or an adhesive gap. An adhesive ensures an additional adhesive connection of the two connecting surfaces at the adhesive location between the two bodies.

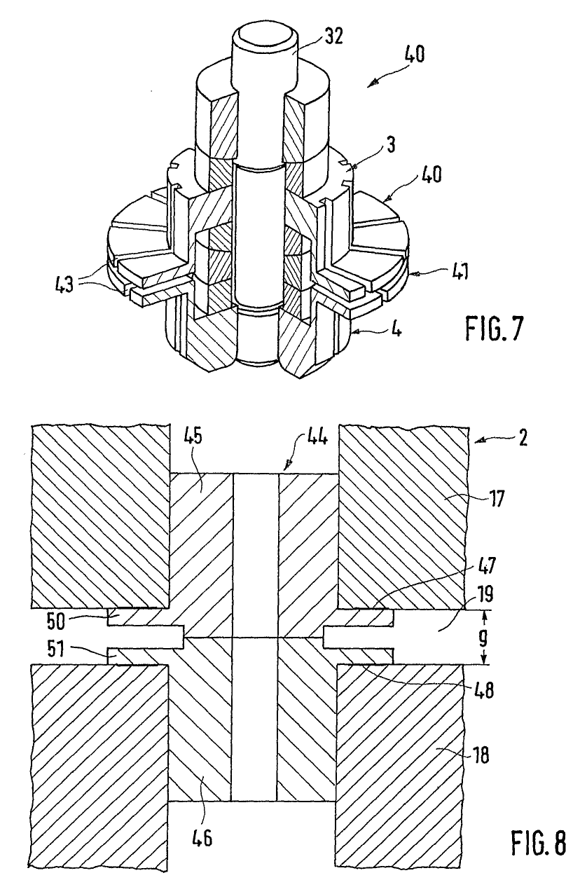

DE 197 57 529 A1 relates to a positioning table with at least one assembly body of a first material having a plurality of deepenings to which a cover plate of a second material is fixed. In FIGS. 8 to 10 examples of fixing two bodies by an adhesive are shown wherein deformations caused by shrinking of the adhesive are diminished by insertion of an additional element between the bodies to be fixed together. The additional element has an elasticity which is substantially smaller than that of the bodies and thus reduces the force on the adhesive area.

U.S. Pat. No. 4,826,303 pertains to an arrangement for connecting bodies wherein thermally-related constraining forces on the bodies are minimised. It is intended to prevent constraining forces resulting from thermally-induced tensions when connecting two bodies by utilising a suitable connecting member. The connecting member is wedge-shaped and its temperature movement is compensated for one or more compensating elements disposed between the connecting member and the bodies to be connected.

Gluing is the most common technique to construct a structure from such materials as are required for extreme ultra violet lithography. The resulting joint is however no longer removable, and there might be additional issues such as creeping and out-gassing of glues, especially when employed in a high vacuum environment, additionally to stringent thermal stability requirements. Furthermore, most structural adhesives have coefficients of thermal expansions substantially higher than 50*10⁻⁶ K⁻¹. The thickness of the adhesive layer itself contributes thus significantly to the overall thermal stability of the resulting structure.

Another possible joining technique is to provide for interface surfaces between different components which are brought into intimate contact via some preloading mechanism such as spring preloaded bolts. This method, however, requires very accurately machined interface surfaces on all components to ensure acceptably uniform contact stress distributions. Furthermore, friction between these surfaces would also create hysteresis which should be avoided in order to guarantee that the structure behaves elastically when subjected to vibrational disturbances. To achieve this, it is desirable to have a physical separation between structural components of glass ceramics of 0.2 mm to 4 mm or in general of more than about 0.2 mm.

It is an object of the present invention to provide an assembly structure of high stability against thermal changes.

According to the invention an assembly structure with a connecting body is provided wherein the body comprises at least a first part and a second part. The assembly structure comprises an assembly, the body and the assembly both extending in a first direction, the parts of the body having a common area of contact extending in a second direction which is at least substantially extending in a rectangular or perpendicular direction as to the first direction, the first part and the second part each being connected to the assembly by a bridging member wherein the first and the second part have a first distance and a second distance, respectively, from the common area of contact.

The thermal length expansion of the assembly over a third distance equals or corresponds to the sum of distances of the at least first and second parts and is compensated by the thermal expansions of the at least first and the second parts, wherein the sum of the products of the distances of the at least first and second parts and the coefficients of thermal expansion of the at least first and second parts equals the product of the length and the coefficient of thermal expansion of the assembly or the assembly means.

The second direction B can be perpendicular to the first direction A. However, depending on the ratio of the thickness of the first and second parts in the direction perpendicular to the first direction A to the distance or length from the common area to the bridging means, the direction of common area can be in a range of angles in an interval between 45° and 135° relative to the first direction A, which is understood as substantially rectangular or perpendicular. The smaller said ratio is, the wider the interval of angles can be. For applications according to the present invention an angle of the common area of contact relative to the first direction A of 80° up to 100° is preferred.

The first and the second distance is a measure of the extension of the first and second parts from the common area of contact of the first and second parts to the respective bridging members. The thickness of said bridging members in the respective directions of the first and second distances is small compared to said respective distances, preferably smaller than ⅓ of said respective distances, such that the thermal expansion of these bridging members in the direction of said distances can be neglected in comparison to the thermal expansion of the parts in the direction of the distance to the respective bridging member. This rule holds, if the materials of the bridging members have the same or a smaller coefficient of thermal expansion than the parts. If this is not the case, the thickness of the bridging members is even smaller than the above value, such that the thermal expansion of the bridging members can be neglected, else the thermal expansion of the bridging members is considered in the determination of the first and second distances.

Further, the common area of contact not necessarily has to be a plane surface. Also other surfaces like any curved surfaces or surfaces with any profiles which are in contact with each other are possible. In these cases the above mentioned angle is an angle of a planar plane, being tangential to the curved surface.

The invention also refers to an assembly structure comprising a connecting body with a first part and a second part, each parts having a cross section in form of a “U” with two first branches extending in a first direction, and an assembly, also extending in the first direction, the parts of the body having a common area of contact at the ends of one of the first branches of each part, the area of contact extending in a second direction which is at least substantially rectangular or perpendicular as to the first direction, the connecting body comprises second branches of the parts each having flanges which form areas of contact with the assembly. A first distance between the centres of the areas of contact with the assembly being equal to a second distance in the other branch of the first part and a third distance in the other branch of the second part, wherein the thermal length expansion of the assembly over the first distance is compensated by the thermal expansions of the sum of the second and the third distances in the other branch of the first and the second parts, wherein the sum of the products of the distances of the first and the second parts with the respective coefficients of thermal expansions of the first and second parts equals the product of the length and the coefficient of thermal expansion of the assembly means or the assembly.

For the area of contact extending in the second direction, also the above comments regarding the range of angles can be applied.

Another assembly structure according the invention comprises a connecting body with a first part and a second part, each having a cylindrical cross section in form of a “U” with an inner and an outer branch each extending in a first direction and an assembly, extending in the first direction at least partially around the connecting body, the parts of the body having a common area of contact at the ends of the inner branches of each part, the area of contact extending in a second direction which is at least substantially rectangular as to the first direction, the outer branches each forming areas of contact with the assembly, the centres of the areas of contact having a first distance equal to a second distance in the inner branch of the first part and a third distance in the inner branch of the second part, wherein the thermal length expansion of the assembly over the first distance is compensated by the thermal expansions of the second and the third distances of the first and the second parts wherein the sum of the products of the distances of the at least first and second parts and the coefficients of thermal expansion of the at least first and second parts equals the product of the length (the first distance) and the coefficient of thermal expansion of the assembly means or the assembly.

The invention also covers an assembly structure comprising a connecting body with a first part and a second part, each part having a cylindrical cross section in form of a “U” with an inner and an outer branch each extending in a first direction, and an assembly, the assembly extending in the first direction at least partially around the connecting body, wherein the assembly comprises two parts separated by a gap with a central line, the outer branches each forming areas of contact with the assembly, wherein the composition of the inner branches is chosen in that way that they compensate for thermal expansions in the outer branches and in the parts of the assembly between lines of zero expansion in the areas of contact with the assembly.

In the preceding two embodiments of the invention the cross section of the parts of the connecting body is cylindrical, meaning cylindrical for at least a section of the connecting body or said parts. Preferably the U-shape of the cross-section is in the direction of the assembly. The lines of zero expansion in the areas of contact with the assembly are given by lines perpendicular on the area of contact, located at positions which will not move, if the area of contact and the connecting body is heated uniformly.

In this assembly structure it may be foreseen that both the inner and the outer branches, or at least one of said branches, contain elements of zero thermal extension whereby the element of zero thermal extension in the inner branches corresponds to the element of zero thermal expansion in the outer element (or the assembly) and has the same length as it in the first direction.

The element of zero thermal extension of the outer element or the assembly preferably is formed by material between the lines of zero expansion. Elements of zero thermal expansion are formed of materials or comprise materials with very small coefficient of thermal expansion like ceramics.

In such an assembly structure the element of zero thermal extension in the outer branches may be composed of the gap and two regions formed by the areas of contact which are divided by a line of zero thermal expansion, whereby the regions are adjacent to the gaps and extend to the lines of zero thermal expansion.

The invention pertains to an assembly structure comprising a connecting body consisting of at least a first and a second part, and an assembly means or an assembly consisting of at least a first and a second part separated by a gap wherein the first part of the connecting body has a first surface extending to the proximity of the gap between the first and the second part of the assembly means, and the second part of the connecting body has a second surface extending to the proximity of the gap.

In another embodiment the assembly comprises a connecting body consisting of at least the first and the second part, the assembly means or the assembly consisting of at least a first and a second part separated by a gap wherein the first part of the connecting body has a first flange with a first surface extending into the gap and the second part of the connecting body has a second flange with a second surface protruding into the gap.

According to the invention an assembly structure is created which comprises a connecting body. The connecting body consists of at least a first and a second part and may comprise connection means, the body being connected to assembly means or an assembly of a ceramic or any other material wherein the assembly consists of at least a first and a second part separated by a gap wherein the first part of the assembly has a first surface extending in the gap and the second part of the assembly means has a second surface extending in the gap.

In another embodiment according to the invention an assembly structure is provided wherein at least the first and the second part of the body are protruding in the gap of the assembly and connecting the first part of the body to the first part of the assembly and the second part of the body to the second part of the assembly at the first and the second surface, respectively.

In an advantageous embodiment of the assembly structure at least the first or the second part or both parts are connected to the assembly means by gluing, i.e. by an adhesive or by brazing, cold bonding, chemical bonding or glass bonding.

Preferably, at least the first or the second part of the connection body are glued to the assembly in the gap or in the proximity of the gap.

In another embodiment it is foreseen that the at least first and the second part of the body comprise different materials having different coefficients of thermal expansion.

It is advantageous when there are provided means of equalising different expansions of at least the first and the second part of the body caused by different coefficients of thermal expansion.

It is further advantageous, if the assembly structure has an inner branch of the body which comprises a first part having a first coefficient of thermal expansion which is zero, and in the outer branch in a distance between two lines of zero expansion pieces of the body of the same length as the first part are provided, whereby the pieces are bridging a gap between them and have the lines of zero thermal expansion thereby equalising the zero thermal expansion of the first part.

In another embodiment of the assembly structure at least two parts of the body are protruding in the gap, connecting each of the parts to each of the first and the second surfaces of the assembly in the gap, the parts of the body being separated by a second, smaller gap which is extending in the gap whereby a spacer element is provided in the body which has the same height as the gap.

An advantageous assembly structure comprises a body wherein at least the first and the second part of the body are both extending at least substantially in parallel and are separated from one another by a gap in longitudinal direction, assembled in an at least partially circular assembly of ceramic material or any or other material of low or near zero thermal expansion wherein the materials of the first and the second parts of the body are chosen in a way to provide for equal thermal expansion.

The assembly may comprise a body wherein the first and/or the second part is at least substantially of a metal or consists of a material of a high elastic limit, e.g. a carbon fibre composite.

In another embodiment the body is extending substantially longitudinally between the first and the second part of the assembly and wherein the body is more elastic in radial direction than in longitudinal direction.

In another embodiment the gap is extending throughout the assembly means, or the assembly structure is separated by a gap.

In another embodiment the first and the second parts of the body are connected to the assembly means only throughout the gap in the assembly means.

Especially, in the case that the body is connected to the assembly or assembly structure with a layer of adhesive means, the layer of adhesive is less than 100 μm, preferably less than 50 μm, thick.

In another embodiment the assembly means has a cylindrical opening to receive the body therein which has a form which is substantially cylindrical. “Substantially cylindrical” means that at least parts of the body have a cylindrical form, or fit into said cylindrical opening.

In this embodiment, preferably, the first and the second parts of the body have an axisymmetric design, especially in the proximity of the gap or those pieces of the first and the second part which are protruding to the gap.

In another embodiment of the invention the body comprises a relieving means in the proximity of the cylindrical wall of the assembly means.

In this embodiment the relieving means may be at least one leaf spring extending in tangential direction.

In another embodiment the at least one leaf spring is attached to the assembly means at a flange part of the body.

According to the preceding design of the invention the at least one leaf spring is attached to the assembly in the gap by gluing, brazing, cold bonding or glass bonding.

In another embodiment the relieving means is at least one leaf spring extending in axial direction.

In this embodiment the at least one leaf spring is formed by spark or laser discharge erosion.

In another embodiment the at least one leaf spring is glued to the cylindrical wall of the assembly means.

In any embodiment of the invention the body may comprise a centric opening or vent extending in longitudinal direction.

In a special embodiment of the assembly a means for compensating for a tilted or slanted position of the first part of the body with regard to the second part of the body comprises two spherical calottes in which the first part is pivoted with regard to the second part.

In another embodiment an assembly is provided wherein a cylindrical part forming the outer surface of the body contains radial deepenings extending in the longitudinal axis of the body.

In another embodiment of the invention the body is at least substantially made of a metal and is attached into the assembly means by means of a structural adhesive.

Preferably, the structural adhesive is realised by at least one preloaded part of the body.

In an advantageous embodiment the body consists of two elements extending in the longitudinal direction of the body and mutually adjacent in a plane perpendicular to the longitudinal direction.

In this embodiment the elements may be contacted by a glue extending at least partially in the plane.

Especially, the two parts are joined by a bolt inserted through a central longitudinal hole in the parts.

In another embodiment the body contains a flange extending in direction to the cylindrical wall of the assembly means.

In this embodiment the flange may extend at least partially throughout the gap, arranged in the assembly structure in radial direction in the assembly means.

In another embodiment a circumferential diaphragm is provided in the flange in at least one of the parts of the body.

In this embodiment a peel stress barrier is provided between the diaphragm and the cylindrical wall of the assembly means.

Other advantageous embodiments of the invention are sketched in more detail in the following description and the drawings.

According to the invention assemblies of composite bodies are provided which are to fulfil requirements to ultra high stability as to a thermal expansions in the range of nanometers or of e.g. five angular minutes. These materials are required for a applications in extreme ultraviolet lithography (EUVL) where wavelengths in the range of tens of nanometers are applied. Materials for such applications must have a coefficient of thermal expansion (CTE) which is zero or nearly approximately zero. Such materials are of quartz, ULE, Zerodur or other similar ceramic materials. All these materials are brittle.

According to the present invention an assembly is created which contains or consists of such materials and is highly stable.

The technique of connecting different parts is effected mostly by gluing, brazing or cold bonding, etc. In some situations it is required to connect the parts by wringing or by ansprengen, especially when gassing out or creeping of the adhesive must be avoided. These requirements are given when the assembly is used in ultra high vacuum and when thermal stability is required. Also effects of hysteresis of assembly structures are to be avoided. Often a direct contact between brittle parts has to be avoided.

According to the present invention parts of metal are used, having a low coefficient of thermal expansion, and which are positioned between two assembly means of brittle ceramics. Preferably, a gap of 0.2 to 15 mm between the two assembly means is provided. This gap is bridged by a connecting body arranged between the two assembly means.

To minimise effects of creeping and thermal expansion of the adhesive the glue thickness is made as thin as possible and is loaded only by pressure.

According to the invention the body extending substantially longitudinally between two elements of assembly is more elastic in radial direction than in longitudinal direction to compensate for thermal expansions. Especially, elastic elements make part of the body which are more resilient in radial direction than in longitudinal direction. The required elasticity is supplied by springs or by positioning and combining parts which have different elasticity in different axes. But the combined assembly of the parts warrantees for the required stiffness and admits that parts of metal and of brittle materials may be combined. The different thermal expansions of metal pieces and ceramic pieces are levelled out by the construction which compensates them.

Different models of compensation of different thermal expansions are created by the invention. In an embodiment according to the invention thermal compensation is acquired

Especially, in the embodiment according to claim 1 different thermal expansions are compensated by a height of a plate of zero thermal expansion which is equal to the distance of lines of zero thermal expansion which are positioned in two pieces of a material by which the body is connected to the assembly means.

Especially, thermal compensation is achieved by inserting a disc into the connecting body, having the same thickness as a gap between the assembly means.

In another embodiment of the invention thermal compensation is achieved by combining materials of different thermal expansion in that way that different lengths of pieces of the different materials equalise the difference in thermal expansion.

Without leaving the principle and concept of the invention the combination of materials of different coefficient of thermal expansion can be adapted to build a connecting body which is not subject to any displacements caused by temperature changes.

According to the invention physical gaps between glass ceramic or ceramic structural parts (in general also called substrates) are bridged by a connecting body. It is possible to connect such components in a rigid manner in at least three degrees of freedom, e.g., translations in X-, Y- and Z-directions. Extremely low thermal drifts are attained which are in the order of 0.1 to 10 nm K⁻¹. The assembly is functional in a wide temperature range, e.g. between −30 to 100° C. The assembly is able to sustain axial and transverse loads without permanent deformation. The assembly according to the present invention allows the different glass ceramic components to be detached from each other during manufacturing and service.

The assembly makes use of metallic inserts (or connecting bodies which comprise metallic means) made of a metal preferably with a near zero CTE (e.g. Invar or Super Invar). Such inserts are attached to holes within structural members of the glass ceramic material using structural adhesives, brazing, cold bonding, etc. The inserts protrude form the end surfaces of the glass ceramics to bridge the gap between the both.

The adhesion is applied on the flanged surfaces of the inserts in the above mentioned gap, instead of on the cylindrical surface of the insert and the mounting holes. This is because Invar inserts still have a finite thermal deformation which is higher than required. To minimise thermal drift in the axial direction, the adhesion surfaces between the two inserts and their respective substrates (e.g. ceramics or glass ceramic parts) should be as close to each other as possible. Also, by applying the adhesive to a flat (rather than cylindrical) surface the thickness of the adhesive can be controlled to a very low value (substantially less than 100 μm) and thus minimising the effect of any expansion in the adhesive itself. An adhesive with ultra-low coefficient of thermal expansion is used preferably.

Thermal stability in the radial direction is achieved by axisymmetric design of the insert body at the joint with the assembly means and in particular in the insert part itself. To ensure sufficient radial stiffness, the outer diameter of the insert body is so dimensioned that it is under a slight radial compression when it is fitted in the mounting hole of the assembly means. No adhesive is necessary to be applied to the cylindrical surface of the body. However, thus making sure that any differential expansion between the body and the assembly means takes place outwards from the glued flange surfaces or the contact surfaces of the body and the assembly, and hence has little or no effect on the axial thermal stability of the connection.

Because of the effect that the insert material of the body has a higher coefficient of thermal expansion than the assembly means, it is necessary that radial expansion of the insert body (or connecting body) can be allowed due to the use of relieving materials for the body, at least in a region close to the outer surface of the body, while still providing sufficient stiffness to any transverse loading.

According to the invention this aim is achieved by a particular embodiment in which tangential slits are cut around the outer diameter of a flanged insert (connecting body), forming a number of leaf springs around the circumference of the insert body. Each of the leaf springs is attached to the substrate at its free end, e.g. by gluing a surface of the flange, and at the other end the core of the body comprises fixation means (e.g., screw threads) for the attachment of the opposing body parts or the assembly means. Thus, radial expansion of the insert core due to temperature changes can be easily allowed due to the bending of the leaf springs normal to the spring surfaces.

When an external transverse load is applied in a particular direction, a multiple of leaf springs which are substantially orientated in the load direction will sustain the applied load by tension or compression. As such, though tough they are loaded in shearing than in tension or compression.

In another embodiment, the leaf springs are formed in the axial direction around the circumference of the insert body, e.g. by EDM (=electro-discharge machining) spark erosion. Similar to the embodiment explained above, a thermal connection or anchor consists in the glued surface between the flange and the assembly, and thus the distance between the two anchor points times the coefficient of thermal expansion of the insert body determines its thermal sensivity.

Also similar to the first embodiment, radial thermal expansion of the insert core is compensated by bending of all leaf springs in the radial direction. In the presence of a transverse load the two or more leaf springs, the cross section of which is substantially parallel to the direction of the applied load, serves to resist deflection and hence contribute to the majority of the stiffness. The leaf springs contribute to ensure that the insert body moves in a pure radial direction and help to prevent pitching of the insert body, which is an advantage of this design.

In another embodiment in which the structural components are to be joined together permanently, the two flanged insert parts can be combined in one solid piece. An axial hole through a pin of the body provides means of venting in vacuum applications, as well as a location for drilling in case that solid pin has to be removed later on.

In case that the joint has to be separable later, the two insert bodies can be fixed together with a hollow bolt. The hole in the middle of the bolt serves as vent hole on vacuum applications.

For components which have to be located to each other to a high degree of repeatability, conical holes can be drilled through one or more sets of the insert pairs, through which location pins can be, inserted for positioning.

To ensure that detachable parts are bolted together with highest repeatability and minimal residual stress, a strain free bolting method, such as hydraulic stretching or preheating, can be employed instead of usual torque tightening.

According to the invention a combination of plates of ceramics, especially of Zerodur, is given which are connected together and meet the following requirements: the connection is thermally stable in both the axial and radial directions. Connected plates are capable of separation and reconnection without inducing deformations or high stresses in the structural plates. Connections must be stiff in the lateral direction and, at the same time, relatively compliant in the axial direction. The tensile and compressive stress induced in the ceramic part, especially the Zerodur part, is kept at a low level whereas normal screwed connections would induce too high compressive stresses in the ceramic part and no compensation for differential thermal expansion is included in assemblies according to the state of art. Known assemblies do not permit the separation of plates because they are bonded together.

Another advantage is that assembly structures according to the invention allow for high precision measurements of its positions.

An object of the present invention is to provide an optical assembly which allows for high precision measurements of its positions.

The invention also refers to an assembly structure with an assembly comprising two parts which are separated by a gap and a connecting body comprising a first flange or a first bracket and a second flange or a second bracket extending to the gap and holding a spacer between them. Such an assembly structure may serve as a modular sub assembly in a more complex assembly structure. The connecting body is preferably mounted on a ceramic frame, especially a Zerodur frame, and can be connected and positioned within a larger Zerodur structure.

Such connections fulfil the following requirements: The connections are thermally stable in both axial and radial direction. Such connected support frames are capable of separation and re-connection without inducing deformations and/or high stresses in the structural plates. Additionally, the sub assemblies are removable without axial separation from the main structure or assembly. Connections are relatively compliant in the lateral direction and, at the same time, stiff in axial direction. The tensile and compressive stress induced in Zerodur structures is kept at a low level.

Preferably the spacer that is positioned between the flanges or brackets. It provides for a +/−1.5 mm linear adjustment and for a +/−1° angular adjustment.

In a preferable embodiment of this assembly structure the spacer is of ceramic or glass ceramic material, especially of Zerodur. Preferably, the flanges are designed such that their thermal expansion is self compensating.

According to another embodiment the assembly structure may have a circular or annular form and an opening inside for receiving a connecting body with at least one flange and a peripheral wall, wherein the connecting body has a number of slots in its flange and/or in its wall. The flange may be glued or fixed in another way by its underside on an assembly.

The slots in the flange and, additionally, also in the wall serve to limit the level of radial thermal expansion. Thus the material of the body receives a certain elasticity in the regions where the slots extend. The so formed “spring” elements, beginning in the flange and optionally continuing in parts of the wall deform as an Invar insert expands, reducing thus the level of stress transmitted to the Zerodur plate, and at the same time they provide the required radial compliance.

Under shock loading it is possible that some spacer connections will experience radial loads of the order 1000 N. It will therefore be necessary to pre-load the connections using a force of approximately 8 kN. Pre-loading and unloading of the connections using a force of load to a fixing bolt and tightening or undoing the nut of the bolt. Tensioning spring elements maintain a nearly constant pre-load over small temperature variations.

A degree of radial compliance is provided by creating spring elements which deform as an insert, e.g. of Invar, expands. In order to be able to tune the radial compliance while maintaining the required axial stiffness, a cut-out is applied near the top of each of the “spring elements” formed by the slots in the flange and in the wall. The cut-out may extend all over the inner wall and thus have a circular form.

The inclusion of the cut-out may introduce an undesirably high peeling stress in the bond lines due to a deformation of the spring elements under radial load. In order to minimise this effect a stress barrier is included, between the cut-out and the flange, such isolating the bond line from the bending stress in the spring elements. Therefore the connecting body has a projection under its flange separated from its peripheral wall by a circular slot. To provide additional joint strength the outer wall of the stress barrier is also bonded to the Zerodur plate or any other assembly.

Any form of connecting, especially bonding, the outer surface of the wall of the stress barrier of the body to an assembly, especially a Zerodur plate, results in high peel stresses being generated under axial load. To overcome this problem the interface between the assembly and the body is made conical whereby the projection of the body and the inner circular wall of the assembly both have a conical form in the region of the stress barrier whereas a cylindrical surface of the body is opposed to the conical surface of the assembly beneath the stress barrier.

This measure reduces the stiffness of the stress barrier at the edge of the glue line allowing stress to be more evenly distributed. The conic angle also aligns the direction of the peeling force to direct shear along the bond line.

The linear position of the mounted sub assembly can be adjusted by increasing or decreasing the thickness of the Zerodur spacing elements.

Assembly structure comprising two assemblies having a circular or annular form and an each having an opening inside receiving a first and a second connecting body, respectively, wherein the connecting bodies each have a peripheral wall which has a number of slots.

Another inventive assembly of e.g. the afore mentioned assembly structure is disclosed wherein the bodies each have circular flange covering a front side of the assembly, a circular cut-out in the inner side of their peripheral walls, projections under their flanges separated from their peripheral walls by circular slots wherein the projection and the inner circular wall of the assembly both have a conical form forming a conical interface. In such an assembly structure spacing elements may be provided between the bodies. Spherical elements may be inserted between the bodies to compensate for tiltings of the bodies as to each other.

Also a tensioning spring element may be positioned between or at least at one of the bodies. Elements positioned between the bodies are preferably fixed by a bolt and a nut.

Additionally the object of the present invention is solved by an assembly structure which is compensated regarding thermal expansion in at least one direction A for the application in extreme ultraviolet lithography. The structure comprises an assembly which is extending into the direction of A, a connecting body connected to the assembly by at least two bridging members at contact points, the contact points are separated by a third distance d3 measured into the direction of A, the connecting body comprises a plurality of parts, directly or indirectly connected to the bridging members and at least partly extending into the direction of A, wherein the thermal length variation of the third distance d3 or a part of it is compensated by the thermal length variation of at least one part of the connecting body.

The assembly structure according to the present invention is suitable for the application in extreme UV lithography, however it can also be used in lithography with wavelengths in the range of 157 nm or even larger wavelengths. The connecting body contacts the assembly by the bridging members at contact points. These contact points define a distance which is at least partly compensated regarding thermal length variation. The distance may comprise one assembly material, or if there is a gap in the assembly material, the distance may comprise two different assembly materials, or the distance may be only a gap. Further, the connecting body comprises a plurality of parts. These parts may form a connection to the bridging members. Some of them are directly connected to the bridging members, others may be only indirectly connected to the bridging members, meaning with the help of other parts. The parts are partly extending into the direction of A, meaning, that the parts also can extend under an angle relative to the direction of A which not necessarily have to be zero. However, if the angle is perpendicular to the direction of A, the part is not suitable for the compensation of the length variation of the third distance.

Preferably the plurality of parts comprising two parts which are extending into the direction of A, having a first and a second length d1 and d2 (d5, d6) into the direction of A, wherein the thermal length variation of the third distance d3 is compensated by the thermal length variation of the first and second length d1 and d2. In this embodiment the two parts may have a common area of contact on one side of the parts, while the respective other side of the parts is connected to the bridging members. Preferably the third distance d3 (d4) is characterized by a coefficient of thermal expansion CTE3, the first and second parts with the respective first and second lengths d1, d2 (d5, d6) are characterized by respective first and second coefficients of thermal expansion CTE1 and CTE2, and the compensation of the length variation of the third distance d3 is compensated by the thermal length variation of the first and second part by the respective variation of the first length d1 (d5) and second length d2 (d6) such that d3*CTE3=d1*CTE1+d2*CTE2 (d4*CTE3=d5*CTE1+d6*CTE2).

In an further preferred embodiment of the above assembly structure, the assembly comprises a gap d0 which is separating the assembly into two subassemblies, each subassembly comprises a contact point connecting the bridging members. Preferably each subassembly have an extension d3a, d3b (d4a, d4b) from the gap d0 to the respective contact point into the direction of A, and both extension defining the third distance d3 (d3=d3a+d3b, or d4=d4a+d4b) which is compensated regarding thermal length variation.

In an preferred embodiment of the above assembly structure the body comprises a gap d0 in at least one part or between two adjacent parts. In this embodiment advantageously subassemblies can be connected on the at least two parts, separated by the gap d0, such that said subassemblies are also separated from each other due to the gap d0 of the body.

Preferably in the above embodiments of the assembly structure the bridging members of the connecting body are extending almost perpendicular to the direction A, and/or the bridging members and/or the connecting body comprise elements of an U-shaped form.

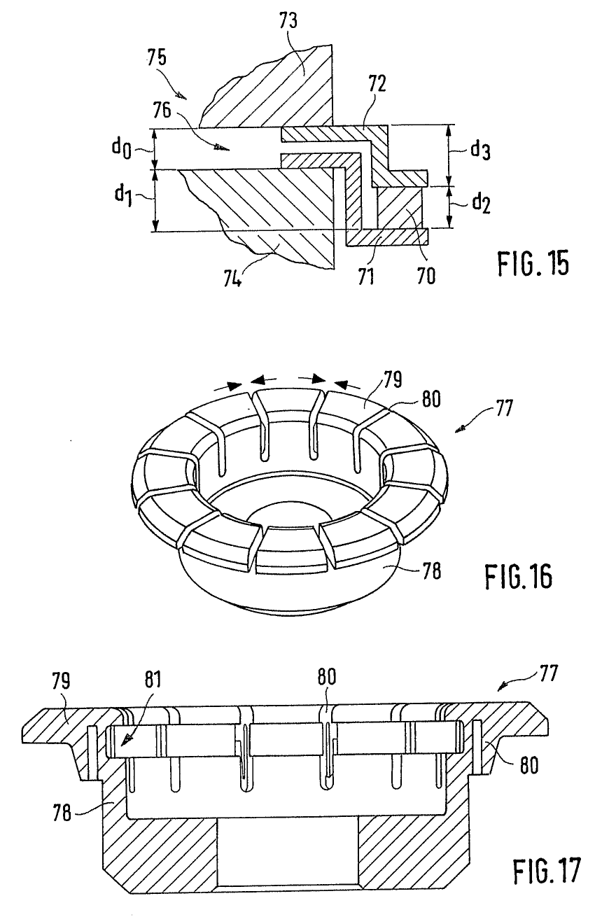

In a further preferred embodiment of the assembly structure according to the present invention, the bridging members comprise shifting means to shift the parts of the body, extending into direction A, along this direction by a shifting distance relative to the contact points. With this embodiment it is possible to achieve that the parts of the body which are compensating any thermal length variation of the assembly along the third distance d3 between the contact points of the bridging members (which also can comprise a gap d0 or can be a gap d0) can be shifted into the direction of A, such that for example the third distance and the compensating parts are arranged opposite to each other, or are shifted by any distance. One example will be described in connection with the embodiment shown in FIG. 15.

Embodiments of the invention will now be described now, by way of example only, with reference to the accompanying drawings in which:

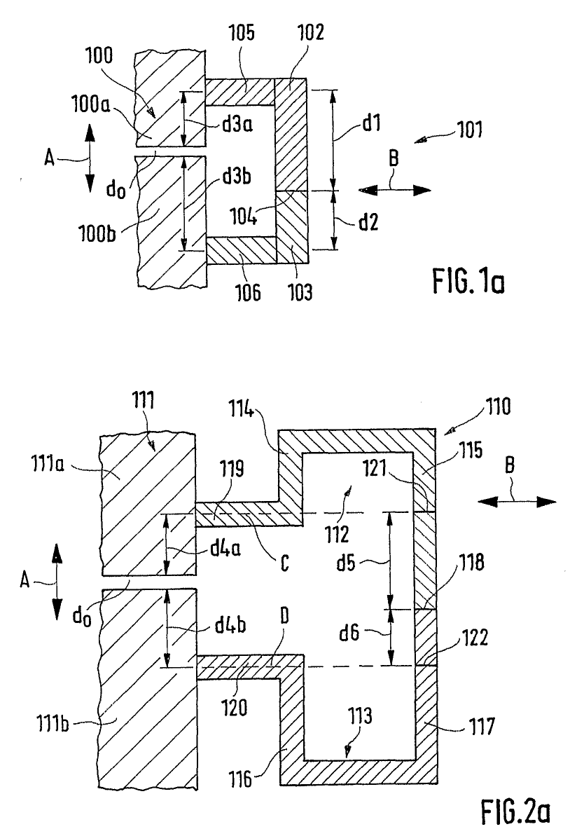

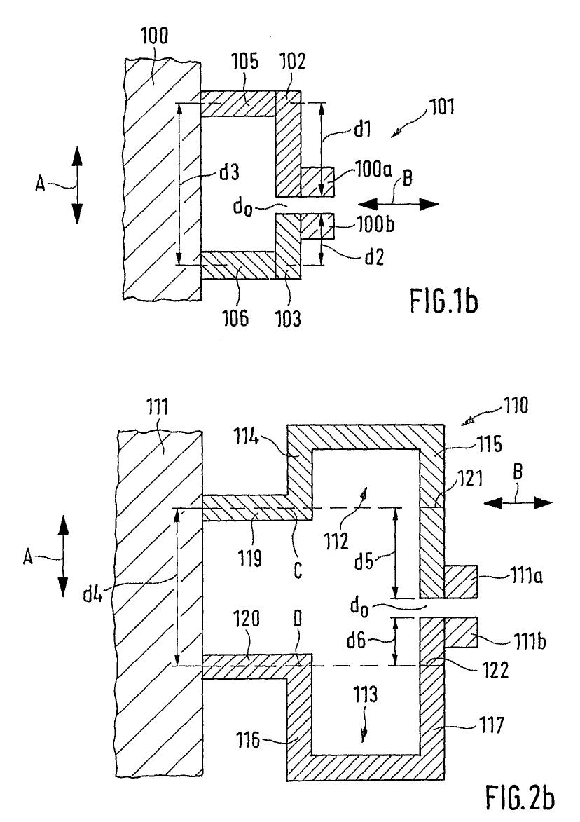

FIG. 1 is a cross-section of an assembly and a connecting body,

FIG. 1a is a cross-section of an assembly structure with an assembly and a connecting body, where the assembly is divided into two subassemblies by a gap,

FIG. 1b is a cross-section of an assembly structure with an assembly and a connecting body, where the connecting body comprises a gap, and where separated subassemblies are connected to the body,

FIG. 2 is a cross-section of another assembly and a connecting body,

FIG. 2a is a cross-section of the assembly structure of FIG. 2 in which the assembly is divided into two subassemblies by a gap,

FIG. 2b is a cross-section of the assembly structure of FIG. 2 in which the connecting body comprises a gap, and separated subassemblies are connected to the body,

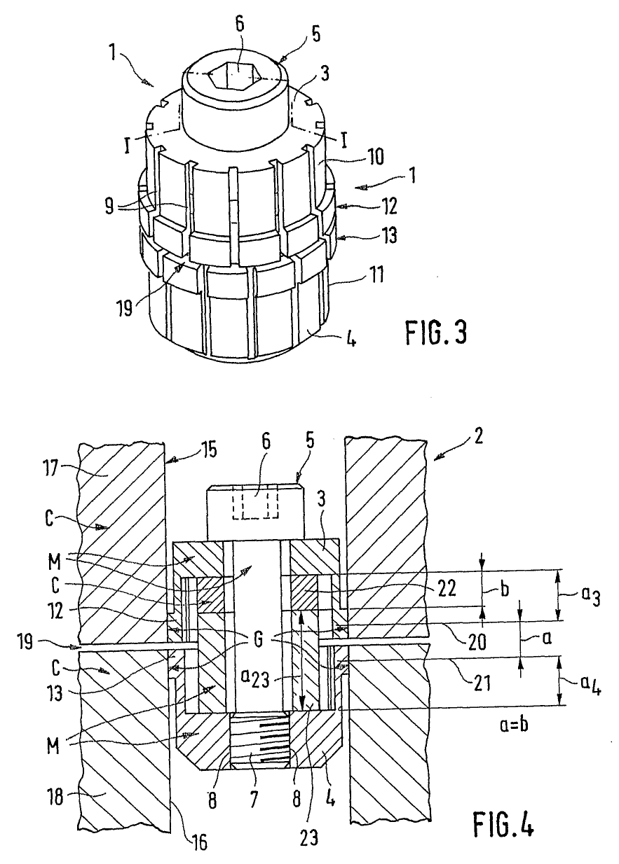

FIG. 3 is a perspective view on a body to be assembled in a assembly means,

FIG. 4 is a cross section of the body of FIG. 1 according to a cross line II-II in FIG. 1, assembled in the assembly means,

FIG. 5 is a cross section of another body to be assembled in the assembly means,

FIG. 6 is a cross section of another body to be assembled in the assembly means,

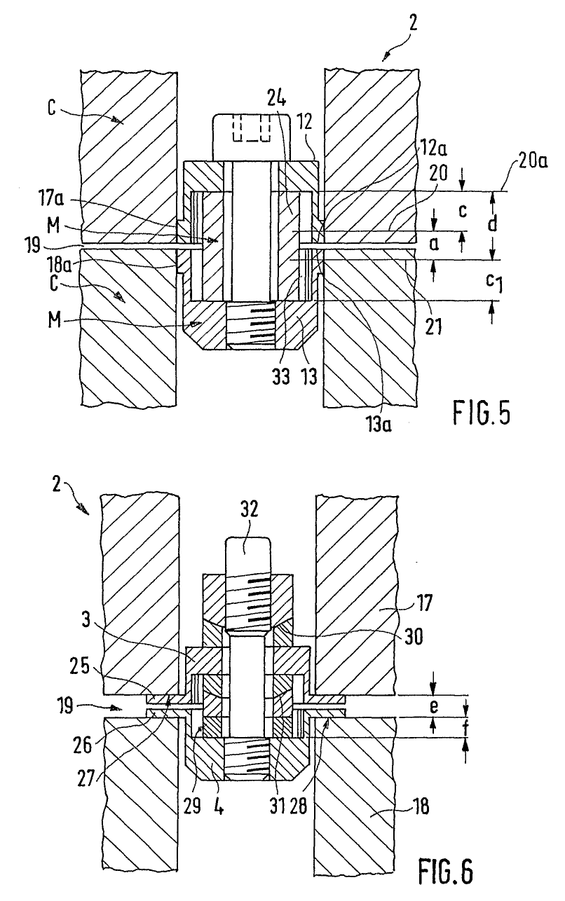

FIG. 7 is a perspective view of the body of FIG. 6 wherein elements are partially removed,

FIG. 8 is a cross section of another body assembled in the assembly means according to a cross line VI-VI in FIG. 8,

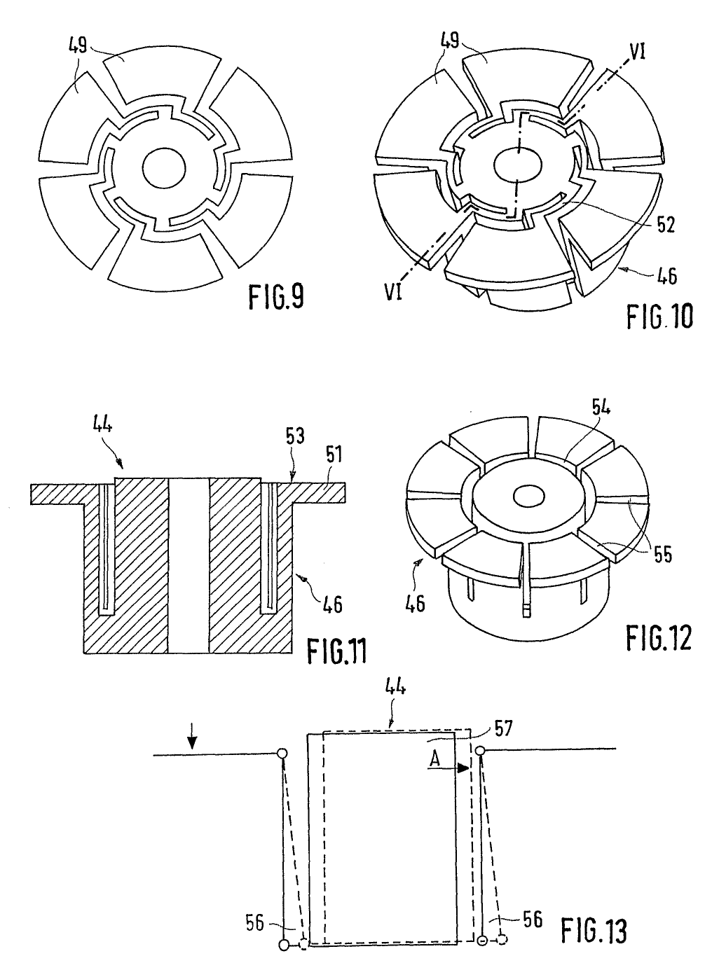

FIG. 9 is a schematic plan view of the body of FIG. 6 with tangential leaf springs,

FIG. 10 is a perspective view of the body of FIGS. 6, 7,

FIG. 11 is a cross-sectional view of the body of FIG. 6 with leaf springs in axial direction,

FIG. 12 is a perspective view of the body of FIG. 9,

FIG. 13 is a schematic view of a body which is partially tilted by positioning it in the assembly means,

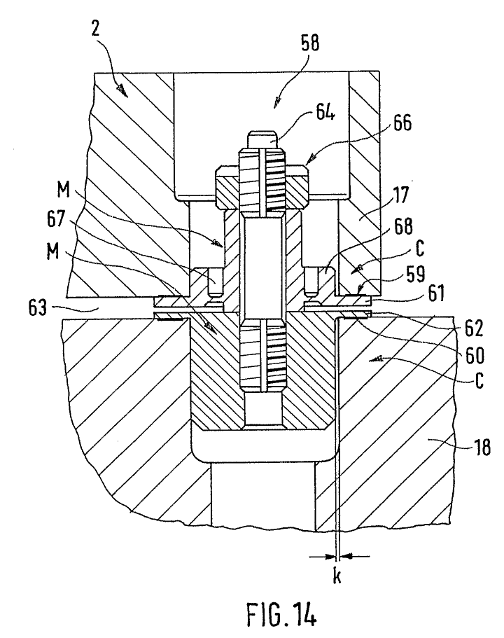

FIG. 14 is a cross-sectional view of a body with flanged parts, a diaphragm and a peel barrier,

FIG. 15 is a cross-section of a spacer positioned between two brackets,

FIG. 16 is a perspective view of a body which can be positioned in an assembly,

FIG. 17 is a cross-section of the body of FIG. 16,

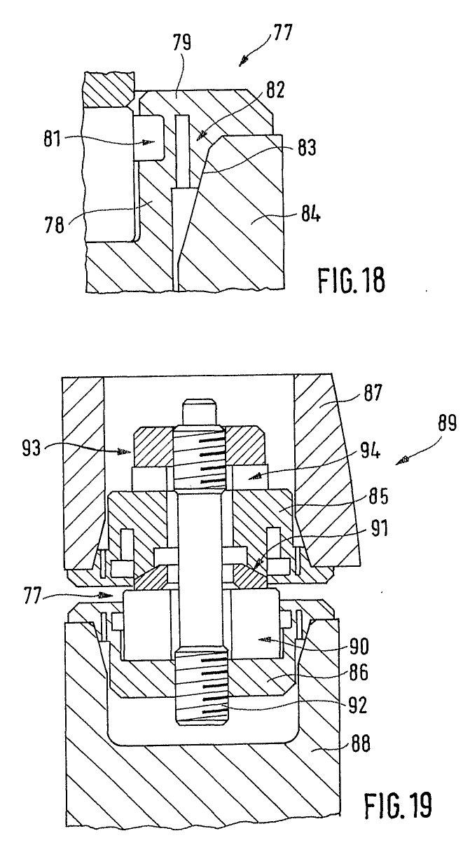

FIG. 18 is an enlarged partial view of the body of FIG. 17 wherein the body is positioned in an assembly, and

FIG. 19 is a cross-section of an assembly comprising two bodies between elements of the assembly.

One of the principles of the present invention consists in compensating for different thermal expansion in one spatial direction. If an assembly 100 (FIG. 1) of an assembly structure has a coefficient of thermal expansion CTE₁₀₀ and if a body 101 comprising two parts 102, 103 is fixed to the assembly 100, wherein the assembly 100 and the body 101 both extend in a direction A, the parts 102, 103 have a common area 104 of contact extending in a direction B which is at least substantially extending in a rectangular or perpendicular direction as to the direction A. Both parts 102, 103 are connected to the assembly 100 by a bridging member 105, 106, respectively. Preferably but not necessarily the bridging members are of the same material as the respective parts which are connected or attached to them. The parts 102, 103 have a distance or length d1, d2, respectively, from the common area of contact.

The thermal length expansion of the assembly 100 over a distance d3 equals and corresponds to the sum of the length expansions over the distances d1, d2 of the parts 102, 103 (resulting in d3=d1+d2 for a temperature range in which the thermal compensation is valid). The compensation is done by the thermal expansions (CTE₁₀₂, CTE₁₀₃) of the parts 102, 103, wherein the sum of the products of the distances of the at least first and second parts d1 and d2 and the coefficients of thermal expansion, (d1*CTE₁₀₂+d2*CTE₁₀₃) of the parts 102, 103 equals the product of the length and the coefficient of thermal expansion (CTE₁₀₀) of the assembly means, d3*CTE₁₀₀:

d1*CTE₁₀₂+d2*CTE₁₀₃=d3*CTE₁₀₀.

The above mentioned compensation is valid, if there is a constant temperature distribution without temperature gradients. This principle advantageously can be used to position at least two parts of an assembly with very high accuracy relative to each other.

A first example of such a precise positioning technique according to the present invention is shown in FIG. 1a, where similar or the same parts as in FIG. 1 are designated with the same reference numerals. There a first subassembly 100a and a second subassembly 100b (both forming the assembly 100) are positioned relative to each other by application of the body 101 (as already described in connection with FIG. 1) which is connected to the subassemblies 100a and 100b by the bridging members 105 and 106. Important is that the first and second subassemblies 100a, 100b are separated by a gap do. Such a gap do is especially important, if different subassembly materials 100a and 100b should be connected. For example, if metal is connected to ceramic or glass or glass ceramic material like Zerodur. If there would be no gap do, there could occur friction between the two subassemblies 100a and 100b. Such friction can result in various disadvantages, especially if the subassemblies 100a and 100b are parts in a projection optical box (POB) of a projection system used in lithography. Such friction may result in hysteresis effects during vibrations such that the vibrational states are difficult to control or to predict, or are completely uncontrollable. Further, also unwanted parasitic particles can be produced.

A further advantage of having a gap between the assemblies is that manufacturing tolerances can be considered in a better way.

Additionally there is no direct transfer of forces, torques and momentums from one subassembly 100a to the other subassembly 100b which is of importance if one subassembly or both subassemblies are sensitive elements or comprise sensitive elements, or if they are made of or comprise brittle material like Zerodur or other glass, ceramic or glass-ceramic material.

Having a gap do of a certain size between the two subassemblies 100a and 100b which are connected by the body 101 can also be of advantage in certain applications like vacuum applications. Since the connection of two subassemblies, especially the connection of two planar surfaces usually behave like a virtual leakage. This virtual leakage can be reduced by providing a gap between the subassemblies or the surfaces of the subassemblies which are facing to each other. Additionally, outgassing effects are reduced such that stable vacuum conditions are achieved in a shorter time.

As already mentioned, the main advantage of the present invention is the very precise positioning of at least two subassemblies 100a and 100b such that at least their distance in one direction A is almost constant, even if the temperature varies from a first temperature to a second temperature, and if there is no temperature gradient along said one direction A and no temperature gradient perpendicular to this direction. In this case the relation between the various geometrical and material properties should be:

d1*CTE₁₀₂+d2*CTE₁₀₃=d3a*CTE₁₀₀ₐ+d3b*CTE_{100b}

The better this equation is technically realized, the better the gap do is kept constant if the temperature is changed.

In this embodiment of the present invention the two subassemblies 100a and 100b can be positioned relative to each other with an accuracy of about 20 nm/K (nanometer per Kelvin of temperature change of the system, meaning the subassemblies 100a, 100b and the body 101) up to 0.1 nm/K. This means that one subassembly can be positioned relative to another subassembly at a well defined distance do which is almost constant regarding changes in temperature within the given parameters, or even better, also depending also on the size (geometrical dimensions) of the assembly or subassemblies and the body.

Further, the present invention is not restricted to compensate the relative position of two assemblies against variations in temperature in only one direction (or better one dimension). The shown principle can be extended such that the compensation is done in two or even three dimensions. In general it is possible that at least two selected points, each on an other subassembly, have an almost fixed distance from each other in the range of 20 nm/K up to 0.1 nm/K.

Additionally, even temperature gradients can be considered, if the gradients are known and of almost constant or reproducible value.

In FIG. 1b a second embodiment of the present invention is shown, where the same or similar parts are numbered with the same reference numerals as in the previous figures. In this embodiment there is no common area 104 of the body 101, and the subassemblies 100a and 100b, which should have an almost fixed distance from each other, are fixed on the first part 102 and the second part 103 of the body 101. Additionally the subassemblies 100a and 100b are separated by the gap d₀, and there is no common area of the first and the second part 102, 103 of the body. Further, the first and the second parts 102 and 103 are connected by e.g. bridging members 105 and 106 to an assembly 100, and these bridging members are separated by a distance d3. Here the condition for an almost constant gap d₀ (regarding changes in temperature) is:

d1*CTE₁₀₂+d2*CTE₁₀₃=d3*CTE₁₀₀

The embodiment of FIG. 1b offers the additional advantage that apart from the almost constant distance d₀ between the subassemblies 100a and 100b (mounted on the first and second part 102, 103 of the body 100), also the position of one of these subassemblies 100a (or 100b) relative to the assembly 100, fixed to the bridging members 105 and 106, is well defined. This means that the construction can be done such that there is no relative shift between the assembly 100 and one of the subassemblies 100a or 100b regarding the direction A (defined by the distance of the connection areas of the bridging members 105, 106 with the assembly 100).

Of course, by reducing the gap d₀ in the embodiments according to FIG. 1a and FIG. 1b to zero, an embodiment according to FIG. 1 can be achieved, especially, if the subassemblies 100a and 100b are made from the same material. So FIG. 1 represents a special embodiment of the present invention in which two subassemblies can be positioned relative to each other without a gap do.

Another assembly structure (FIG. 2) comprises an assembly 111, and a connecting body 110 with two parts 112, 113 each having a cross section in form of a “U”. Each part 112, 113 has two branches extending in a direction A of the assembly 111.

The parts 112, 113 have a common area 118 of contact at the ends of the branches 115, 117; the area 118 extends in a direction B which is at least substantially rectangular or perpendicular as to the direction A. The branches 114, 116 each have flanges 119, 120 which form areas of contact with the assembly 111.

A distance d4 between the centres of the areas of contact of the flanges 119, 120 with the assembly 111 is equal to a distance d5 in the branch 115 of the part 112 and a distance d6 in the branch 117 of the part 113. The thermal length expansion of the assembly 111 over the distance d4 is compensated by the thermal expansions of the sum of the distances d5, d6 in the branches 115, 117 which is:

d4=d5+d6

The sum of the products of the distances d5, d6, and the respective coefficients of thermal expansion CTE₁₁₅, CTE₁₁₇ equals the product of the length d4 and the coefficient of thermal expansion of the assembly CTE₁₁₁:

d5*CTE₁₁₅+d6*CTE₁₁₇+X=d4*CTE₁₁₁.

The expression “X” represents potential additional terms, if there are more than two different materials connected to each other in the region which corresponds to d4 in the branches 117 and 115. This is, in the case of two materials, the region d5+d6 as shown in FIG. 2 for two materials. For example, if a third materials X1 is used with a coefficient of thermal expansion of CTE_{X1} and with a length d_{X1}, the equation would be:

d5*CTE₁₁₅+d6*CTE₁₁₇+d_{X1}*X1=d4*CTE₁₁₁ and d5+d6+d_{X1}=d4.

This scheme can be extended to additional materials.

Back to the embodiment of FIG. 2, the length of the distance d5 is determined by the fact that its upper end 121 lies on a virtual line C which passes perpendicular through the centre of the area of contact of the flange 119 with the assembly 111, whereas the length of the distance d6 is determined by the fact that its lower end 122 is connected to the centre of the area of contact of the flange 120 with the assembly 111 by a virtual line D perpendicular to the centre area. It is thus possible to adopt different thermal expansions in parts 112 and 113 in that way that they compensate the thermal expansion in the assembly 111. In this concept the thermal expansions in the parts 112, 113 in the branches 114, 115, 116, 117 on the outer side of the lines C, D, meaning outside the distance d4 between the contact of the flanges 119, 120, is without any influence of the common thermal extension of the assembly 111 and the body 110.

FIG. 2a shows a similar embodiment of the present invention as FIG. 2, wherein the same or similar parts are designated with the same reference numerals. The difference to the embodiment of FIG. 2 is that there is a gap d₀ in the assembly 111 between the flanges 119 and 120, dividing the assembly 111 in two subassemblies 111a and 111b. The subassemblies 111a and 111b in general have not be made of the same material. The advantage of the embodiment of FIG. 2a is similar to the one of FIG. 1a, meaning that the distance of the two subassemblies are kept almost constant, even if the temperature of the system (comprising subassemblies 111a, 111b and body 110) is changing. As already described in connection with FIGS. 1, 1a and 1b, also in this embodiment the distance do between said subassemblies 111a and 111b can be kept constant on a level of about 20 nm/K up to 0.1 nm/K. The condition for this is given by:

d5*CTE₁₁₅+d6*CTE₁₁₇=d4a*CTE₁₁₁ₐ+d4b*CTE_{111b}

The better this equation is technically realized, the better is the gap do kept constant if the temperature is changed.

Analogous to the embodiment of FIG. 1b, FIG. 2b shows an additional embodiment in which the flanges 119 and 120 are fixed to an assembly 111, and in which there is no common area 118 of the branches 117 and 115 (as it is in the embodiment shown in FIG. 2). The branches separated by the gap do each comprise subassemblies 111a and 111b which are also separated by this gap. Additionally, as in the previous embodiments, said gap is almost constant if there is a change in temperature. This is achieved by the following condition:

d5*CTE₁₁₅+d6*CTE₁₁₇=d4*CTE₁₁₁.

Similar as the embodiment shown in FIG. 1b, the embodiment of FIG. 2b offers the additional advantage that apart from the almost constant distance do between the subassemblies 111a and 111b (mounted on the branches 115, 117 of the body 110), also the position of one of these subassemblies 111a (or 111b) relative to the assembly 111, fixed to the flanges 119 and 120, is well defined. This means that the construction can be done such that there is no relative shift between the assembly 111 and one of the subassemblies 111a or 111b in the direction A (defined by the distance of the connection areas of the flanges 119 and 120 with the assembly 111). As already mentioned above, of course, by reducing the gap d₀ in the embodiments according to FIG. 2a and FIG. 2b to zero, an embodiment according to FIG. 2 can be achieved, especially, if the subassemblies 111a and 111b are made from the same material. So FIG. 2 also represents a special embodiment of the present invention in which two subassemblies 111a and 111b can be positioned relative to each other without a gap d₀.

According to the present invention as described in the FIGS. 1, 1a, 1b, 2, 2a and 2b, one intention is to compensate thermal expansion such that two subassemblies can be positioned relative to each other with very high accuracy and almost independent of temperature variations. Or in general, that at least two reference points, each on an subassembly, have a defined distance from each other, wherein the distance is compensated regarding changes of temperature of the subassemblies. However, the present invention also can be used to provide a defined coefficient of thermal expansion (CTE) between at least two reference points, each on an other subassembly. As an example it is referred to FIG. 2b, where the reference points are on the surfaces of the subassemblies 111a and 111b which are facing against each other.

d5*CTE₁₁₅+d6*CTE₁₁₇−d4*CTE₁₁₁=d₀*CTE.

By combination of the distances d4, d5, d6 and the respective materials, a defined coefficient of thermal expansion CTE can be assigned to the gap d₀. This CTE can be made very small and can be used similarly as a gear reduction.

The assemblies 100, 111 or subassemblies 100a, 100b and 111a, 111b may have a cylindrical form enclosing the bodies 101, 110, respectively, whereas the bodies 101, 110 may have a plurality of bridging members 105, 106 or flanges 119, 120. Other flanges or bridging members may be positioned opposite to the members 105, 106 and the flanges 119, 120, respectively.

A body 1 (FIG. 3) to be assembled in an assembly means or an assembly 2 (FIG. 4) comprises a first flanged part 3 and a second flanged part 4. Both parts 3, 4 are connected to one another by a screw 5 which has a hexagon socket 6 (e.g. for an Allen key) and a thread 7 assembled in a threaded bore hole 8 of part 4.

Radial elasticity is given by slits 9 on cylindrical surfaces 10, 11 of parts 3, 4. Each of the parts 3, 4 comprises a flanged element 12, 13 to be connected with inner cylindrical walls 15, 16 of elements 17, 18 of the assembly 2. Elements 17 and 18 are separated by a gap 19.

Parts 3, 4 consist of a metal as Invar or Super Invar whereas elements 17 and 18 consist of ceramics as Zerodur (in FIG. 4 all parts of metal are indicated by arrows “M”, all parts of ceramics are indicated by arrows “C”).

To permit inserting of body 1 in the inner cylindrical opening of the assembly means 2 the flanged elements 12, 13 are connected to the inner walls 15, 16; preferably, they are glued to the inner cylindrical walls 15, 16 of elements 17, 18 by an adhesive directly adjacent to gap 19 or in proximity of it at the inner walls 15, 16 (in FIG. 4 through FIG. 7 the glued parts are indicated by arrows “G”).

Each of the flanged elements 12, 13, as it consists of a metal, undergoes a thermal expansion when it is heated up. But the parts 12, 13 connected to the inner walls 15, 16 of the elements 17, 18 are hardly shifted as a result of thermal expansion when the elements 12, 13 are warmed. Thus a distance a between the flanges 12 and 13, indicated by lines 20 and 21 does not or negligibly change during heating up, whereas elements 17, 18 do not or nearly not change their volume as they consist of ceramics. This means that the middle of elements 12, 13 through which lines 20 and 21 are extending do not shift as a result of thermal expansion, for this, these lines are designated as lines of zero thermal expansion or zero thermal extension. Thus, flanges 12, 13 permit a connection of a metallic or at least substantially metallic body to a ceramics assembly means 2, and this connection is such that the gap 19 between the elements 17 and 18 (which are made of ceramic, glass ceramic or glass) is temperature compensated and therefore almost constant, as described above in connection with FIGS. 1, 1a, 1b, 2, 2a and 2b. For this, the body 1 allows to connect for example two assemblies or subassemblies 17, 18 with each other in a way that the body 1 itself will not change the thermal behaviour of the assemblies or subassemblies regarding thermal expansion.

In order to provide for the same total thermal expansion in the inner part of body 1 circular spacer elements 22, 23 are positioned between parts 3, 4 in such a way that spacer 22 is of ceramics and has the same zero thermal expansion as it is over the distance a between lines 20, 21. Thus, spacer 22 has the same height b as height a between lines 20, 21. On the other hand, spacer 23 consists of a metal as parts 3, 4 thus permitting the same thermal expansion in longitudinal or axial direction of body 1 in the juxtaposed inner spacer elements 22, 23 and in the more outside positioned parts 3, 4 comprising the flanges 12, 13. This can be expressed as:

a₃*CTE₃+a₄*CTE₄=b*CTE₂₂+a₂₃*CTE₂₃

If, for example CTE₃=CTE₄=CTE₂₃ and if CTE₂₂=0 (if Zerodur is used), then it follows that a=b.

In another embodiment of the invention (FIG. 5) the problem of different thermal expansions of materials combined together in one body is solved by compensating different thermal expansion coefficients in a longitudinal direction wherein the body is built by different “columns”. One column consisting of spacer element 24 and another column consisting of elements or parts 12, 13 spaced by a cylindrical gap 33 of the same height as the circular spaced “columns”. Distance “a” between the lines of zero thermal expansion 20, 21 does not have any or only negligibly thermal expansion, whereas elements 12, 13 have a coefficient of thermal expansion CTE_{c}, and the thermal expansion over the distance c has to be equalised to that of a spacer element 24 with a coefficient of thermal expansion CTE_{d} in that way that the product

c*CTE_{c}=d*CTE_{d} or more precise

(c₁+c)*CTE_{c}=d*CTE_{d}.

This means, in a more generalised way, that combinations of different materials arranged juxtaposed to each other and separated by a gap could result in zero or nearly zero coefficient of thermal expansion (for the gap, meaning that the gap width does not change with temperature), if the products of their distances and their coefficients of thermal expansion CTEₙ, CTEₘ are made equal. This is expressed by the equation:

n1*CTEₙ₁+n2*CTEₙ₂ . . . =m1*CTEₘ₁+m2*CTEₘ₂ . . . ,

wherein spacers of different lengths n1, n2, . . . are connected to form a first column separated by a gap from a second column with spacers of lengths m1, m2, . . . .

In another embodiment (FIGS. 6, 7) elements 12, 13 have flanged parts 25, 26 which are protruding into the gap 19 between elements 17, 18 of the assembly means 2. At surfaces 27, 28 they are connected by an adhesive to corresponding surfaces of the elements 17, 18. In order that surfaces 27, 28 do not change their positions in the case of temperature changes, a distance e between surfaces 27, 28 has to be equalised by a spacer 29 (of e.g. ceramics) of the same thickness f (e=f), but with a CTE of zero or substantially zero, whereas spacer 31 has the same CTE as parts 3 and 4.

Additionally, two spherical washers 30, 31 are provided to equalise any tilting of a screw 32 or a bolt in the interior of the body 1.

The two adjacent elements 3, 4 both equipped with flanges 40, 41 may comprise channels 43 to compensate for different thermal expansion in radial direction of body 1.

In another embodiment (FIG. 8) a body 44 consisting of two parts 45, 46 of metal with a low coefficient of thermal expansion is positioned between the two elements 17, 18 of glass ceramics separated by a gap 19 of width g which is chosen as small as possible in order to minimize any residual thermal expansion due to parts 45 and 46.

To connect the parts 45, 46 to the elements 17, 18 an adhesive is applied only on plane surfaces or abutting faces 47, 48 of flanges 50, 51 of the parts 45, 46. To minimise thermal drift in the axial direction, the adhesion are as close together as possible. Instead of an adhesive other methods of connected can be used as brazing or cold bonding (chemical bonding). The body 44 is so dimensioned that it is under a slight radial compression when fitted in the hole provided by elements 17, 18. The necessary elasticity in radial direction is provided by elements which relieve the tension.

These elements are leaf springs 49 (FIGS. 9, 10) distributed over the whole circumference of parts 45, 46 of body 44. The leaf springs 49 extend as well over the axial partition of parts 45, 46 as over their flanges 50, 51. Each of the leaf springs 49 is equipped with a small bridging part 52 which provides for high elasticity.

In another embodiment of body 44 (FIG. 11) springs 53 including or comprising flanges 50, 51 are separated from the inner partition of parts 45, 46 by a circular slit 54 and radial slits 55 at equal distances. In this case, there has to be a radial clearance between the part 46 and the elements 17 or 18 between which body 44 is positioned. Body 44 is fixed by its flanges 51 which are glued to element 17 or 18.

The constructions containing springs 49, 53 provide for high elasticity of body 44 and are able to balance any tilted position with regard to any of the elements 17, 18 of the assembly means 2 as is sketched schematically by FIG. 13. In this case than only the outer parts 56 of body 44 are tilted whereas an inner part 57 rests in a perpendicular position though shifted aside, as shown by arrow A. This construction also allows for thermal expansion.

In another embodiment (FIG. 14) a body 58 is positioned between elements or subassemblies 17, 18 of assembly means 2 by gluing or bonding surfaces 59, 60 of flanges 61, 62 in a gap 63 between the elements 17, 18. A fixing screw 64 is tightened to the body 58 together with a nut 66. Thereby a tensile load is applied to the body 58.

By this design the effect of differential thermal expansion is limited to only the distance 63 between the elements 17, 18. This is due to the fact that each flange 61, 62 or connector is bonded to the surface 59, 60, respectively. So only material beyond the bond lines at surfaces 59, 60 contributes to thermal expansion. The effect of the adhesive is minimised by using a very thin glue layer of, e.g., 20 μm.

The level of radial thermal expansion is limited by the physical size of the components. The level of stress in the glue layer and in the elements 17, 18 is held within acceptable limits. In an embodiment body 58 may be referenced to the elements 17, 18 at different joining points.

A diaphragm 67 is provided to compensate for misalignments caused by a less than perfect positional replacement between the body, especially of its upper part, with regard to the elements 17, 18. Because of the axial compliance of the diaphragm 67 misalignments are compensated for.

As the inclusion of the diaphragm 67 introduces an undesirable high peeling stress in the bond lines of surfaces 59, 60 this effect is minimised by a stress barrier 68 between the diaphragm 67 and in proximity to the flange 61. The stress barrier 68 isolates the bond line form the bending stress in the diaphragm 67. The body 58 is formed in that way that it is relatively more resilient in axial or longitudinal direction than in radial direction. A radial clearance k is provided between body 66 and the element 18 which serves as an conical stress barrier.

In a further embodiment (FIG. 15) a spacer 70 is clamped between brackets 71, 72 which are each fixed by bonding to elements 73, 74 of an assembly 75. The brackets 71, 72 are used as shifting means, to shift parts of the connecting body, like a spacer 70 into the direction of A. The direction A is here defined as the distance of the gap, since the connecting points of the bridging members (here parts of the brackets 71, 72 which are connected to the elements 73, 74) are the areas were the elements 73, 74 are bonded to the brackets 71, 72. The elements 73, 74 are made of a ceramic material, especially Zerodur. The spacer 70, preferably is also of a ceramic material, most preferably of Zerodur. As the spacer 70 and the elements 73, 74 do not undergo any thermal expansion and the distance of the gap between the elements 73, 74 is equal to the height of the spacer 70 any expansions of the brackets 71, 72 can take place within a gap 76 and outside of the space filled by the spacer 70. The contribution of a connecting material, as a glue, between the brackets, which may consist of Invar or any other metal, is minimised by using a very thin layer of, e.g., 20 μm thickness. The condition for thermal compensation, meaning that the gap 76 with gap-width do is temperature independent is:

d1*CTE₇₁=d2*CTE₇₀+d3*CTE₇₂.

If the space 70 is made of Zerodur or other material with zero coefficient of thermal expansion, the respective term in the above given equation can be neglected.

Another body 77 (FIG. 16) which may be put within elements 17, 18 of FIG. 8 or 14 comprises an cylindrical wall 78 and a circular flange 79 at an end of the wall 78. Slots 80 through the flange 79 and the adjacent part of the wall 78 give radial compliance to the body 77.

In order to tune the compliance it is advantageous if a circular cut-out 81 (FIG. 17) is applied to the inner side of the wall 78 near the top of each of the spring elements formed in the wall 78 and the flange 79 by the slots 80. A further measure to influence the elasticity of the body 77 consists in adding a stress barrier 82 (FIGS. 17, 18) which is positioned between the cut-out 81 and the gluing flange 79. The barrier 82 isolates the bond line from the bending stress in the spring elements.

Additionally, the body 77 is provided with a conical outer surface 83 (FIG. 18) bordering to an corresponding surface of an element 84 of an assembly structure. The stress barrier 82 has not necessarily to be made conical as shown in FIG. 18. Usually it is sufficient, that the stress barrier has a stiffness (rigidity) which is changing at least in one direction.

In another embodiment (FIG. 19) two bodies 85, 86 assembled as body 77 (FIG. 19) are positioned between two elements 87, 88 of an assembly 89. Between the bodies 85, 86 a spacer 90, preferably of Zerodur or any other thermally non-expanding ceramic material, is assembled.

Spherical elements 91 positioned between the spacer 90 and the upper body 85 permit a compensation of any tilting of the bodies 85, 86 as to each other. The bodies 85, 86 are fixed by a bolt 92 and a nut 93. Between the body 85 and the nut 93 tensioning spring elements 94 are added to provide for axial compliance.

The present invention is not limited to the explicitly described embodiments, the present invention also comprises embodiments, resulting from the exchange and/or combination of features of different embodiments.

1. An assembly structure with a connecting body comprising at least a first connecting body part and a second connecting body part, and an assembly, said connecting body and said assembly both extending in a first direction (A), said connecting body parts of said connecting body having a common area of contact extending in a second direction (B) which is at least substantially extending in a perpendicular direction as to said first direction (A),
said first connecting body part and said second connecting body part each being connected to said assembly by a bridging member wherein said first connecting body part and said second connecting body part extend over a first distance (d1) and a second distance (d2), respectively, from said common area of contact,
wherein the thermal length expansion of a part of said assembly extending over a third distance (d3), said third distance corresponding to the sum of the extensions (d3=d1+d2+) of said at least first and second connecting body parts is compensated by the thermal expansions of the said at least first and the second connecting body parts, wherein the sum of the products of said distances (d1, d2) of said at least first and second connecting body parts and the coefficients of thermal expansion (CTE₁₀₂, CTE₁₀₃) of said at least first and second connecting body parts equals the product of said third distance (d3) and the coefficient of thermal expansion (CTE₁₀₀) of said part of said assembly:
d1*CTE₁₀₂+d2*CTE₁₀₃+ . . . =d3*CTE₁₀₀.

2. An assembly structure with a connecting body comprising a first connecting body part and a second connecting body part, each connecting body parts having a cross section in form of a “U” with two first branches extending in a first direction (A), and an assembly also extending in said first direction (A), said connecting body parts of said connecting body having a common area of contact at the ends of one of said first branches of each connecting body part, said area of contact extending in a second direction (B) which is at least substantially perpendicular as to said first direction (A),
said connecting body comprises second branches of said connecting body parts each having flanges which form areas of contact with said assembly,
a first distance (d4) between the centres of said areas of contact with said assembly being equal to a second distance (d5) in said first branch of said first connecting body part and a third distance (d6) in said first branch of said second connecting body part,
wherein the thermal length expansion of the part of the assembly extending over the first distance (d4) is compensated by the thermal expansions of the sum of said second (d5) and said third distances (d6) in said first branch of said first and said second connecting body parts, (d4=d5+d6), wherein the sum of the products of said distances (d5, d6) of said first and said second connecting body parts with the respective coefficients of thermal expansion (CTE₁₁₅, CTE₁₁₇) of said first and second connecting body parts equals the product of the length and the coefficient of thermal expansion of said part of said assembly:
d5*CTE₁₁₅+d6*CTE₁₁₇+ . . . =d4*CTE₁₁₁.

3. An assembly structure with a connecting body with a first connecting body part and a second connecting body part, each having a cylindrical cross section in form of a “U” with an inner and an outer branch each extending in a first direction, and an assembly, extending in said first direction at least partially around said connecting body, said connecting body parts of said connecting body having a common area of contact at the ends of said inner branches of each connecting body part, said area of contact extending in a second direction which is at least substantially perpendicular as to said first direction,
said outer branches each forming areas of contact with said assembly
the centres of said areas of contact having a first distance equal to a second distance in said inner branch of said first connecting body part and a third distance in said inner branch of said second connecting body part,
wherein the thermal length expansion of a Part of said assembly extending over said first distance is compensated by the thermal expansions over said second and said third distances of said first and said second connecting body parts
wherein the sum of the products of said distances of said at least first and second connecting body parts and the coefficients of thermal expansion of said at least first and second connecting body parts equals the product of said first distance and the coefficient of thermal expansion of said part of said assembly means.

4. An assembly structure, comprising a connecting body with a first connecting body part and a second connecting body part, each connecting body part having a cylindrical cross section in form of a “U” with an inner and an outer branch each extending in a first direction, and an assembly, said assembly extending in said first direction at least partially around said connecting body,
wherein said assembly comprises two assembly elements separated by a gap with a central line,
said outer branches each forming areas of contact with said assembly, wherein the composition of said inner branches is chosen in that way that they compensate for thermal expansions in said outer branches and in the parts of the said assembly between lines of zero expansion in said areas of contact with the said assembly.

5-6. (canceled)

7. An assembly structure comprising a connecting body consisting of at least a first and a second connecting body part, and an assembly consisting of at least a first and a second assembly element separated by a gap, wherein said first connecting body part of said connecting body has a first surface extending to the proximity of said gap and said second connecting body part of said connecting body has a second surface extending to the proximity of said gap.

8. The assembly according to claim 7, wherein said first connecting body part of said connecting body has a first flange with a first surface extending into said gap and said second connecting body part of said connecting body has a second flange with a second surface protruding into said gap.

9. An assembly structure comprising a connecting body consisting of at least a first and a second connecting body part, said connecting body being connected to an assembly made of a ceramic material wherein said assembly consists of at least a first and a second assembly element separated by a gap, wherein said first assembly element of said assembly has a first surface extending to said gap and said second assembly element of said assembly has a second surface extending to said gap.

10. The assembly structure according to claim 9, wherein at least said first and said second connecting body part of said connecting body are protruding in said gap of said assembly and connecting said first connecting body part of said connecting body to said first assembly element part of said assembly and said second connecting body part of said connecting body to said second assembly element of said assembly at said first and said second surface, respectively.

11. The assembly structure according claim 7, wherein at least one of said first and said second connecting body part of said connecting body is connected to said assembly by one of gluing, brazing, cold bonding and glass bonding.

12-14. (canceled)

15. An assembly structure according to claim 9 wherein an inner branch of said connecting body comprises a first branch part having a first coefficient of thermal expansion which is zero, and in outer branch of said connecting body is connected to said assembly elements, wherein, in a first direction (A), the dimension of said first branch part is equal to a distance between two lines of zero expansion of said assembly elements that is to be kept unchanged upon a change in the temperature of said assembly structure.

16. The assembly structure according to claim 15, wherein said first branch part is a spacer element having the same height as said gap in said first direction (A).

17. The assembly structure according to claim 68, wherein at least said assembly is made of one of a ceramic material and a material of low thermal expansion.

18. The assembly structure according to any of the preceding claim 68 wherein at least one of said first and said second connecting body part is at least substantially made of one of a metal, a material of a high elastic limit and a carbon fibre composite.

19-21. (canceled)

22. The assembly structure according to claim 11, wherein said connecting body is connected to said assembly with a layer of adhesive means, said layer of adhesive being less than 100 μm thick.

23. The assembly structure according to claim 68, wherein said assembly has a cylindrical opening to receive said connecting body.

24. The assembly structure according to claim 23, wherein said first and said second connecting body part of said connecting body have an axisymmetric design in the proximity of a gap formed between adjacent assembly elements of said assembly.

25. The assembly structure according to claim 23, wherein said connecting body comprises a relieving means in the proximity of said cylindrical wall of said assembly.

26. The assembly structure according to claim 25, wherein said relieving means is at least one leaf spring extending in a tangential direction.

27. The assembly structure according to claim 26, wherein said at least one leaf spring is attached to said assembly at a flange part of said connecting body.

28. The assembly structure according to claim 26, wherein said at least one leaf spring is attached to said assembly in a gap formed between adjacent assembly elements of said assembly by one of gluing, brazing, cold bonding and glass bonding.

29. The assembly structure according to claim 25, wherein said relieving means is at least one leaf spring extending in an axial direction.

30-31. (canceled)

32. The assembly structure according to claim 68, wherein said connecting body comprises a centric opening or vent extending in said first direction (A).

33. The assembly structure according to claim 68, wherein a means for compensating for a tilted or slanted position of said first connecting body part of said connecting body with regard to said second connecting body part of said connecting body comprises two spherical calottes by which said first connecting body part is pivoted with regard to said second connecting body part.

34. The assembly structure according to claim 68, wherein a cylindrical part forming an outer surface of said connecting body contains radial deepenings extending along a longitudinal axis of said connecting body.

35-36. (canceled)

37. The assembly structure according to claim 7, wherein said connecting body consists of two connecting body parts extending in a longitudinal direction of said connecting body and mutually adjacent in a plane perpendicular to said longitudinal direction.

38. The assembly structure according to claim 37, wherein said connecting body parts are connected by at least one of a glue extending at least partially in the plane and one of a bolt or a screw inserted through a central longitudinal hole in said connecting body parts.

39-41. (canceled)

42. The assembly structure according to claim 68, wherein a circumferential diaphragm is provided in at least one of said connecting body parts of said connecting body.

43. The assembly structure according to claim 42, wherein a peel stress barrier is provided between said diaphragm and a cylindrical wall of said assembly.

44. An assembly structure with an assembly comprising two assembly elements which are separated by a gap and a connecting body comprising one of a first flange and a first bracket as well as one of a second flange and a second bracket extending to said gap and holding a spacer between them.

45. The assembly structure according to claim 44, wherein said spacer is made of one of ceramic material, glass ceramic material and Zerodur.

46. (canceled)

47. An assembly structure which has a circular or annular form and an opening inside for receiving a connecting body with a peripheral wall and at least a flanged, wherein said connecting body has a number of slots in at least one of said flange and said wall.

48. The assembly structure according to claim 47, wherein the connecting body (77) has a circular flange covering a front side of the assembly.

49. The assembly structure according to claim 47, wherein said connecting body has a circular cut-out in the inner side of said peripheral wall.

50. The assembly structure according to claims 47, wherein said connecting body has a projection under said flange separated from said peripheral wall by a circular slot.

51. The assembly structure according to claim 47, wherein said projection and said inner circular wall of said assembly both have a conical form, forming a conical interfaces.

52-63. (canceled)

64. The assembly structure according to claim 7, wherein to at least two assembly elements of said assembly, separated by said gap, subassemblies are connected, being also separated from each other due to the gap of said assembly.

65-67. (canceled)

68. An assembly structure comprising
a first assembly element, a second assembly element and a connecting body; said connecting body connecting and positioning said first assembly element and said second assembly element such that said first assembly element, in a first direction (A), is located adjacent to said second assembly element;
said connecting body extending along said first direction and comprising a plurality of connecting body parts each having a coefficient of thermal expansion (CTE) and a dimension along said first direction (A);
one of said plurality of connecting body parts being inserted in a recess of one of said assembly elements;
at least two of said plurality of connecting body parts being made of different materials having different coefficients of thermal expansion (CTE);
said dimensions along said first direction (A) and said coefficients of thermal expansion (CTE) of said plurality of connecting body parts being selected such that, upon a change in the temperature of said assembly structure, a relative position between a first reference location on said first assembly element and a second reference location on said second assembly element remains substantially unchanged along said first direction (A).

69. The assembly structure according to claim 68, wherein said connecting body part being inserted into said recess is more elastic in a second direction (B) than in said first direction (A); said second direction (B) being perpendicular to said first direction (A).

70. The assembly structure according to claim 69, wherein said connecting body part being inserted into said recess provides said greater elasticity perpendicular to said first direction (A) via a plurality of leaf springs, said leaf springs extending in said first direction (A).

71. The assembly structure according to claim 68, wherein
said plurality of connecting body parts comprises at least a first connecting body part, a second connecting body part and a third connecting body part;
said first connecting body part being inserted in a first recess of said first assembly element;
said second connecting body part being inserted in a second recess of said second assembly element;
said third connecting body part being located between said first connecting body part and said second connecting body part.

72. The assembly structure according to claim 68, wherein said plurality of connecting body parts are detachably connected to each other.

73. The assembly structure according to claim 68, wherein said first assembly element and said second assembly element, in said first direction (A), are separated by a gap.

74. The assembly structure according to claim 72, wherein said dimensions along said first direction (A) and said coefficients of thermal expansion (CTE) of said plurality of connecting body parts are selected such that, upon a change in the temperature of said assembly structure, the width of said gap along said first direction (A) remains substantially unchanged.
